(19) United States
(12) Patent Application Publication
(10) Pub. No.: US 2026/0180223 A1
(43) Pub. Date: Jun. 25, 2026

(54) CONNECTOR

(71) Applicant: A. RAYMOND ET CIE, GRENOBLE (FR)

(72) Inventor: Anthony Sanchez, Grenoble (FR)

(21) Appl. No.: 19/126,296

(22) PCT Filed: Aug. 22, 2023
(86) PCT No.: PCT/EP2023/072974

§ 371 Date: May 1, 2025

(30) Foreign Application Priority Data
Nov. 8, 2022 (FR) 2211604

(51) Int. Cl. H01R 13/11; H01R 13/627; H01R 13/639

(52) U.S. Cl. CPC H01R 13/11; H01R 13/6272; H01R 13/6275; H01R 13/639

(57) ABSTRACT

A connector for electrically connect two elementary cells of a battery pack. More particularly, the connector according to the present disclosure is configured to electrically connect the terminals of two adjacent elementary cells.

### CROSS-REFERENCE TO RELATED APPLICATIONS

This application is a national phase entry under 35 U.S.C. § 371 of International Patent Application PCT/EP2023/072974, filed Aug. 22, 2023, designating the United States of America and published as International Patent Publication WO 2024/099610 A1 on May 16, 2024, which claims the benefit under Article 8 of the Patent Cooperation Treaty of French Patent Application Serial No. FR2211604, filed Nov. 8, 2022.

### TECHNICAL FIELD

The present disclosure relates to the field of batteries, and more particularly to connectors intended to be used for electrically connecting elementary cells of a battery pack. Notably, the present disclosure relates to a connector provided with a locking member, which also acts as a “good” connection indicator.

### BACKGROUND

An inter-battery connector known from the prior art is disclosed in European Patent Publication EP3358647.

Notably, and as shown in FIG. 12 of EP3358647, this device comprises a U-shaped connection clip defining a U-shaped channel wherein a connection tab of a battery can be inserted and held by spring action of the connection clip.

The connector also comprises a movable element capable of adopting one or the other of a disengaged position and an engaged position, and which is provided with at least one wedge engaged in the U-shaped channel.

The wedge is, in particular, arranged so that the connection clip has a spacing that is dependent on the position of the movable element. In this respect, the disengaged position and the engaged position are positions of the movable element for which the wedge imposes on the wings of the connection clip, respectively, a first spacing and a second spacing, which is less than the first spacing.

Thus, when connecting the connector to a connection tab of a battery, the movable element is first in its disengaged position in order to provide a sufficient spacing (the first spacing) of the wings of the connection clip and thus allow the insertion of the connection tab into the U-shaped channel. This insertion is then followed by a movement of the movable element from its disengaged position to its engaged position so that the wings of the connection clip are tightened against the tab and maintain the latter by spring action.

Although this device is easy to use, it is not satisfactory.

Indeed, the connection clip proposed in EP3358647 remains bulky and, in some respects, difficult to use when limited workspace is available.

Thus, one aim of the present disclosure is to offer a less bulky connector.

### BRIEF SUMMARY

The aim is achieved by a connector for electrically connecting a terminal of an elementary cell of a battery pack, the terminal projecting with respect to a zone of the elementary cell, a so-called connection zone, the connector comprising:
a male casing provided with a main body forming a housing, a so-called male housing, accessible for an opening, a so-called male opening, formed on a lower face of the main body;
a female casing intended to be attached to the connection zone by one of its faces, a so-called contact face, and so as to form a housing, a so-called female housing, wherein the terminal is housed, the female casing comprising an insertion opening on one of its faces, a so-called insertion face, the female housing generally conforming to the main body so as to allow the insertion of the main body, by its lower face, in the female housing, and the maintenance by snap-fitting of the male casing in a position, a so-called snap-fit position;
a connection member, arranged in the male housing, intended to form a contact with the terminal when the main body is in its snap-fit position;
a locking member, in sliding connection or in pivot connection with the female casing, and capable of adopting, according to a sliding movement or according to a rotational movement, one or the other of a locked position and an unlocked position, the unlocked position being a position for which the locking member allows the insertion of the main body into the female housing to adopt its snap-fit position, the locked position being a position for which the locking member locks the main body in its snap-fit position.

According to one embodiment, wherein the male casing forms a rectangular parallelepiped, while the female casing comprises four side walls, the insertion face is opposite the contact face.

According to one embodiment, the main body comprises four side faces, and the male casing also comprises a secondary body, in the form of a rectangular parallelepiped, surmounting the main body by a face opposite the lower face, the secondary body having a form of a rectangular parallelepiped, one face of the secondary body, a so-called secondary section, extends one of the side faces, a so-called main section, in a coplanar manner, the main section and the secondary section together forming a snap-fit face carrying snap-fit means, and intended to engage with complementary snap-fit means carried by the female casing.

According to one embodiment, the complementary snap-fit means are carried by a side wall, a so-called snap-fit wall, of the female casing facing the snap-fit face.

According to one embodiment, wherein the snap-fit wall comprises, along a direction perpendicular to the contact face, a so-called sliding direction, and starting from the contact face, a first part, an intermediate part and a second part carrying the complementary snap-fit means, the side edges of the intermediate part and of the second part being free in order to allow a bending of the second part around an axis perpendicular to the sliding direction and comprised in the intermediate part, during the snap-fit operation of the male casing with the female casing.

According to one embodiment, the locking member is formed by a one-piece part in sliding connection according to a guiding mode maintained by way of at least one rail, each rail from the at least one rail, extending along the sliding direction from the contact face, is discontinuous at the intermediate part and comprises a first portion and a second portion, respectively, carried by the first part and the second part, the locking member, when it is in its locked position, is engaged in one and the other of the first portion and the second portion of the at least one rail so as to mechanically secure the first part and the second part, whereas when it is in its unlocked position, the locking member is engaged exclusively in the second portion of the at least one rail.

According to one embodiment, the locking member is configured to be snap-fitted against the second section when in its unlocked position, and against the first section, and against the first section when it is in its locked position.

According to one embodiment, the locking member, in the form of a rectangular parallelepiped, comprises a base bearing on one of its faces, a so-called guide face, at least a counter-rail engaging with the at least one rail, the base being further surmounted, by one of its faces opposite the guide face, by two side walls and a thrust wall.

According to one embodiment, the main body comprises two studs each arranged on a different side face, adjacent to the main section, so-called guide faces, the two studs being configured to be guided toward an insertion position, by guide means formed on two side walls adjacent to the snap-fit wall, and so-called guide walls, the insertion position being a position for which the male casing is in the snap-fit position, the two studs also being configured to engage with the locking member so that, when it is in its locking position, the locking member locks the studs in their insertion position.

According to one embodiment, the means for guiding a guide wall comprises a guide notch that extends from a guide inlet, at the insertion face, toward the contact face, to terminate in an end, a so-called abutment end, at a distance from the contact face, the guide notches being configured so that when the main body is inserted into the female housing, each stud is engaged in a guide notch to be guided along the guide notch up to its insertion position.

According to one embodiment, each stud, once it is engaged in a guide notch, comprises an end portion projecting with respect to the guide wall carrying the guide notch in question, and intended to engage with the locking member.

According to one embodiment, the locking member, in the form of a rectangular parallelepiped, comprises four walls arranged around the side walls of the female casing, the locking member being arranged to slide between one and the other of the locked position and the unlocked position along a direction perpendicular to the guide notches and comprised in a plane defined by one or the other of the guide walls, two walls of the locking member, so-called locking walls and each facing a guide wall, each being configured to engage with the end portion of a stud so that when the locking member is in its unlocked position, each stud can be guided freely in a guide notch, and so that when the locking member is in its locked position, each stud is locked in its insertion position.

According to one embodiment, each locking wall comprises on an inner face, a guide trench that extends from a first end toward a second end and parallel to the guide notches, each locking wall also comprises an oblong hole that extends perpendicularly to the guide trench and from the second end of the guide trench toward a third end, the guide trench being arranged so that, when the locking member is in its unlocked position, the guide trench is opposite one of the guide notches and makes it possible to guide the end portion of a stud, from the first end up to the second end, and to cause the stud to adopt its insertion position, the oblong hole being arranged so that when the locking member goes from its unlocked position to its locked position, the end portion is guided from the second end toward the third end so as to lock the end portion in its insertion position.

According to one embodiment, the guide walls each comprise a flared edge, each flared edge partially providing the sliding connection between the female casing and the locking member.

According to one embodiment, each guide wall comprises a retaining lever at one of its edges, in contact with a flared edge, the retaining lever being adapted to engage with a boss formed on the flared edge, and to allow the locking member to be maintained in one and the other of the locking position and the unlocking position.

According to one embodiment, the connection member comprises at least one clip, the at least one clip comprising a base from which two wings extend essentially symmetrically with respect to the base, between which the terminal, of planar shape, is intended to be inserted when the main body is in its snap-fit position.

According to one embodiment, the connection member comprises a contact section, housed in a housing, a so-called connection housing, arranged in the extension of the secondary body by one of its faces, opposite the second section.

### BRIEF DESCRIPTION OF THE DRAWINGS

Other features and advantages of the present disclosure will emerge from the following detailed description of embodiments of the present disclosure with reference to the appended figures, in which:

FIG. 1 is a schematic depiction, in perspective, of two elementary cells arranged side by side in a battery pack;

FIG. 2 is a schematic depiction, in perspective and according to a partially exploded view, of a connector according to a first example of implementation of the present disclosure;

FIG. 3 is a schematic depiction, in perspective, of the male casing according to the first example of implementation of the present disclosure;

FIG. 4 depicts the male casing shown in FIG. 3 according to a perspective view and from the lower face of the main body of the male casing;

FIG. 5 is a schematic depiction of an example connection member capable of being implemented within the scope of the present disclosure;

FIG. 6 is a depiction of the female casing shown in FIG. 2 according to a perspective view;

FIG. 7 is a depiction of the female casing shown in FIG. 6 according to another perspective view, showing the through-opening and the various sections of the snap-fit wall;

FIG. 8 is a schematic depiction of the female casing shown in FIG. 8 showing details of the insertion opening;

FIG. 9 shows the insertion of the main body into the female housing;

FIG. 10 shows a locking member according to a perspective view and by its guide face, the guide member being suitable for use in the first connector example of the present disclosure;

FIG. 11 shows the locking member of FIG. 10 according to a perspective view and by one of its faces opposite the guide face;

FIG. 12 is a schematic depiction, in perspective and according to a partially exploded view, of a connector according to a second example of implementation of the present disclosure;

FIG. 13 is a schematic depiction, in perspective, of the male casing according to the second example of implementation of the present disclosure;

FIG. 14 is another schematic depiction, in perspective, of the male casing according to the second example of implementation of the present disclosure;

FIG. 15 is a depiction of the female casing shown in FIG. 12 according to a perspective view;

FIG. 16 is another depiction of the female casing shown in FIG. 12 according to a perspective view;

FIG. 17 is a schematic depiction of a male casing inserted into a female casing and showing the end portion of one of the studs;

FIG. 18 is another schematic depiction of a male casing inserted into a female casing and showing the end portion of the other stud;

FIG. 19 shows the locking member according to the second connector example, and according to a perspective view;

FIG. 20 shows the locking member of FIG. 19 mounted with the female casing;

FIG. 21 shows the details of the guide trench and the oblong hole;

FIG. 22 depicts the details of the contact section;

FIG. 23 depicts a connection device; and

FIG. 24 depicts another example of a connection device.

### DETAILED DESCRIPTION

The present disclosure relates to a connector making it possible to electrically connect two elementary cells of a battery pack. More particularly, the connector according to the present disclosure is configured to electrically connect the terminals of two adjacent elementary cells.

Thus, the present disclosure relates to a connector for electrically connecting a terminal of an elementary cell of a battery pack, the terminal projecting with respect to a zone of the elementary cell, a so-called connection zone, the connector comprising:
a male casing provided with a main body forming a housing, a so-called male housing, accessible for an opening, a so-called male opening, formed on a lower face of the main body;
a female casing intended to be attached to the connection zone by one of its faces, a so-called contact face, and so as to form a housing, a so-called female housing, wherein the terminal is housed, the female casing comprising an insertion opening on one of its faces, a so-called insertion face, the female housing generally conforming to the main body so as to allow the insertion of the main body, by its lower face, in the female housing, and the maintenance by snap-fitting of the male casing in a position, a so-called snap-fit position;
a connection member, arranged in the male housing, intended to form a contact with the terminal when the main body is in its snap-fit position;
a locking member, in sliding connection or in pivot connection with the female casing, and capable of adopting, according to a sliding movement or a rotational movement, one or the other of a locked position and an unlocked position, the unlocked position being a position for which the locking member allows the insertion of the main body into the female housing to adopt its snap-fit position, the locked position being a position for which the locking member locks the main body in its snap-fit position.

The male casing can form a rectangular parallelepiped, while the female casing can comprise four side walls, the insertion face being opposite the contact face.

It is understood that the expressions “connection member” and “terminal” are each associated with a connection element, one having a male architecture while the other has a female architecture.

According to the present disclosure, the female casing is intended to be attached to the connection zone of the elementary cell before the latter is assembled with other elementary cells in order to form a battery pack. According to the present disclosure, and in contrast to arrangements known from the state of the art, the female casing comprises, attached in sliding connection, the locking member. This configuration facilitates the association of the male casing with the female casing in order to establish the electrical connection between the connection member and the terminal housed in the female housing.

Furthermore, the locking member also acts as a “good connection” indicator. More particularly, the locking member is configured to allow insertion of the main body into the female housing only when it is in its unlocked position. Additionally, in the presence of the main body, the sliding of the locking member from its unlocked position to its unlocked position is only possible if the male casing is in its snap-fit position.

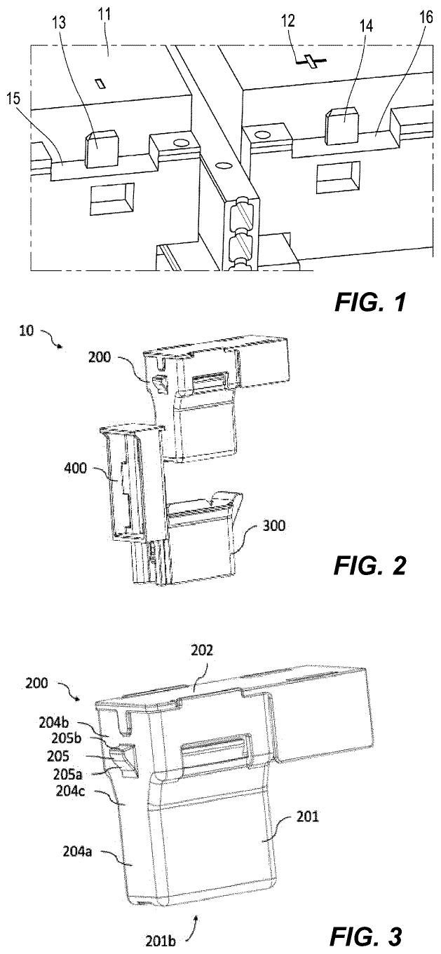

Thus, FIG. 1 depicts two elementary cells 11 and 12, each comprising a terminal 13 and 14 projected with respect to a zone, a so-called connection zone 15 and 16. Each connection zone is essentially planar.

Thus, FIG. 2 depicts a first example of a connector 10 according to the present disclosure.

The connector 10 notably comprises a male casing 200, a female casing 300, a locking member 400 and a connection member. The connection member is not shown in FIG. 2 but is shown by way of other figures and described in the following statement of the present disclosure.

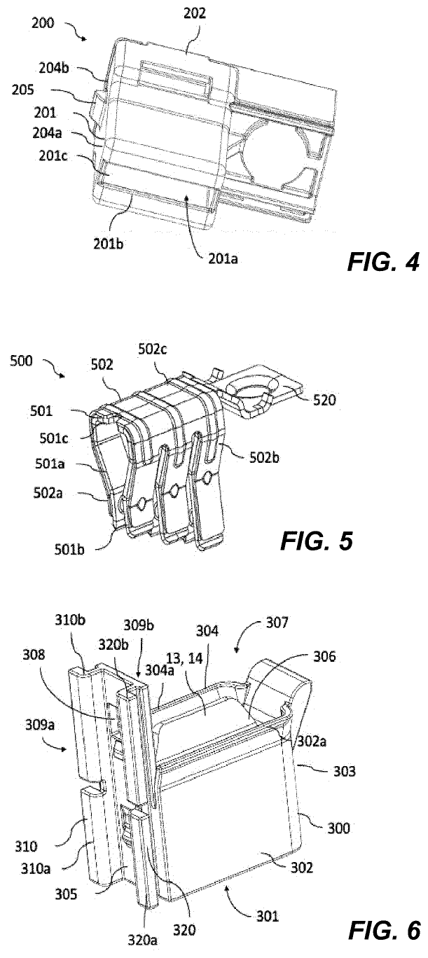

The male casing 200 (also shown in FIG. 3 and in FIG. 4) comprises a main body 201 in the form of a rectangular parallelepiped, forming a housing, a so-called male housing 201a, accessible for an opening, a so-called male opening 201c, formed on a lower face 201b of the main body 201. As shown in FIG. 4, the male opening 201c can take the form of a slot. However, the present disclosure need not be limited to this single form, and the skilled person wishing to implement the present disclosure will be able to consider other forms. The male opening 201c may, for example, cover the entire lower face 201b.

The male housing 201a is furthermore adapted to house a connection member 500 as a fixed connection. By way of example, the connection member 500 may comprise at least one clip. Notably, the at least one clip comprises a base from which two wings extend substantially symmetrically with respect to the base. According to this configuration, a terminal 13 or 14, in the form of a tab, can be inserted and clamped by the two wings in order to establish an electrical contact between the terminal and the connection member 500. It is understood, but this aspect will become clear in the remainder of the wording, that the establishment of contact between the terminal and the connection member 500, involves an insertion, through the male opening, of the terminal into the male housing 201a through the male opening 201c.

Advantageously, and as shown in FIG. 5, the at least one clip may comprise a connection clip 501 and a clamping clip 502. In this respect, the connection clip 501 comprises two connection wings 501a and 501b linked together by a connection base 501c. Equivalently, the clamping clip 502 comprises two clamping wings 502a and 502b interconnected by a clamping base 502c, and arranged on both sides of the connection clip 501 so as to apply a spring force to each of the connection wings 501a and 501b tending to tighten them against each other.

The male casing 200 can also comprise a secondary body 202 in the form of a rectangular parallelepiped. Notably, the secondary body 202 surmounts the main body 201 by a face of the main body and opposite the lower face 201b. More particularly, the secondary body 202 comprises a face, a so-called secondary section 204b in the extension of one of the four side faces of the main body 201 and a so-called main section 204a, which together with the secondary section 204b forms a face, a so-called snap-fit face 204c.

“Side face” is understood to mean a face exposed to the outside environment. The expression “side face” is the opposite of the expression “inner face.”

The secondary body may have a different foundation to that of the main body. For example, the foundation of the secondary body may be greater than that of the main body.

However, according to this first example, the main section and the secondary section are coplanar. This last aspect will not necessarily be verified in the second example, which will be described in the remainder of the wording.

The female casing 300 is provided with four side walls 302, 303, 304 and 305, and is intended to be attached to the connection zone by one of its faces, a so-called contact face 301, and to form a housing, a so-called female housing 306, wherein the terminal 13, 14 is housed (FIG. 6). The female casing 300 also comprises an opening, a so-called insertion opening 307, on one of its faces opposite the contact face 301. The two side walls 302 and 304 each comprise an edge, a so-called inlet edge 302a and 304a, opposite the contact face 301, and partly delimiting the insertion opening 307.

Furthermore, the female housing 306 conforms to the main body 201 so as to allow the insertion of the main body 201, via its lower face 201b, into the female housing 306 and the establishment of a contact between the connection member and the terminal. It is also understood, without it needing to be specified, that the insertion of the main body 201 into the female housing takes place along a direction from the insertion opening 307 toward the contact face 301.

By way of example, for a terminal formed by a (flat) tab and a connection member, which comprises at least one clip, the electrical connection between these two elements is established by inserting and clamping the terminal between the side wings of the clip.

Additionally, the male casing 200 and the female casing 300 comprise, respectively, snap-fit means and complementary snap-fit means configured to engage together. Notably, the snap-fit means and the complementary snap-fit means are configured to hold, by snap-fitting, the male casing 200 when its main body is inserted into the female housing and when the contact between the connection member and the terminal (housed in the female housing) is established.

According to the present disclosure, the snap-fit means are carried by the snap-fit face 204c, and more particularly in this first example, the snap-fit means are carried by the secondary section 204b. Notably, the snap-fit means may comprise a lug 205 projecting with respect to the snap-fit face 204c. In this respect, the lug 205 comprises, along a direction from the main section 204a to the secondary section 204b, an oblique section 205a and an abutment section 205b.

Still in accordance with the present disclosure, the complementary snap-fit means are carried by a side wall, a so-called snap-fit wall 305, of the female casing opposite the snap-fit face when the main body is inserted into the female housing 306. In this respect, the snap-fit wall 305 comprises two essentially parallel faces, and referred to, respectively, as a first face 309a and a second face 309b. Notably, the first face 309a is an outer face of the female housing while the second face 309b is an inner face of the female housing.

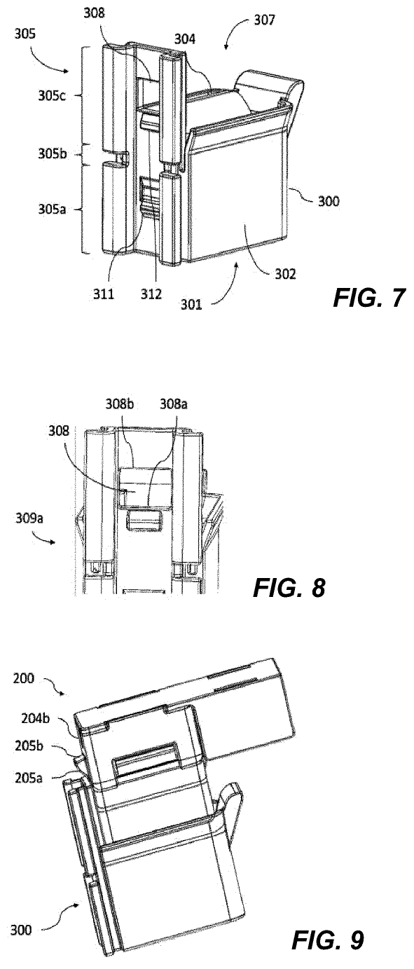

Notably, and in accordance with the first connector example, the snap-fit wall 305 comprises, along a direction, a so-called sliding direction, perpendicular to the contact face, a so-called sliding direction, and from the contact face, a first part 305a, an intermediate part 305b and a second part 305c (FIG. 6 and FIG. 7). Notably, the snap-fit wall 305 is configured to be flexible at the intermediate part 305b. In these regards, the first part 305a attached over the full extent of its two side edges to the side wall 302 on the one hand and to the side wall 304 on the other. On the other hand, the side edges of the intermediate part 305b and the second part 305c are free.

The “side edges” of parts 305a, 305b and 305c are the edges parallel to the extension direction.

This configuration makes it possible to differentiate the rigidity of the first part from that of the intermediate part and of the second part. More particularly, the first part, held by its side edges, is unlikely to deform when a force is exerted thereon. On the contrary, the intermediate part and the second part, whose side edges are free, are susceptible to deformation, and notably to bending, when a force is exerted on the second part.

It is understood that the material forming the female casing, and more particularly the snap-fit wall, is adapted to allow bending of the second part along a direction perpendicular to the plane formed by the snap-fit wall. More particularly, the second part is capable of bending about an axis perpendicular to the sliding direction and included in the intermediate part.

Thus, according to the present disclosure, the snap-fit wall is generally planar as long as no force is exerted thereon and notably on the second part.

Again according to this first example, the complementary snap-fit means are arranged on the second part 305c. These can notably comprise a through-opening 308 opening out through the first face 309a and the second face 309b. The through-opening 308 can form a rectangular window delimited by four inner faces (FIG. 8). Of these four inner faces, two are parallel to the contact face, and are named, along a direction from the contact face toward the female opening, annex face 308a and snap-fit face 308b.

Other configurations can be envisaged to form complementary snap-fit means. Notably, these can comprise a trench or a cavity.

Notably, the snap-fit face 308b is configured to form an abutment against which the lug is intended to abut when the main body 201 is inserted into the female housing 306 in order to establish a contact between the connection member and the terminal housed in the female housing, and to adopt a position, a so-called snap-fit position.

In operation, and upon insertion of the main body 201 of the male casing 200 (shown in FIG. 9), the oblique section 205a is engaged against an edge of the snap-fit wall opposite the contact face. During this engagement, and due to its “oblique” shape, the oblique section 205a exerts a force on the snap-fit wall and more particularly on the second part 305c. This force causes the second part 305c to bend, which opens the way for the main body to be inserted into the female housing. After this insertion, the lug 205 is housed in the through-opening 308, so that the second part 305c becomes planar again, and so that the abutment section 205b is in abutment against the snap-fit face 308b. The main body is now in its snap-fit position, and cannot be removed without bending the secondary section again.

According to the present disclosure, the locking member is in sliding connection with the female casing 300. Notably, the locking member is able to adopt one or other of a locked position and an unlocked position according to a sliding movement. In this respect, the unlocked position is a position wherein the locking member allows insertion of the main body into the female housing to adopt its snap-fitted position, while the locked position is a position wherein the locking member locks the main body in its snap-fitted position.

FIG. 2 shows a locking member 400 formed by a one-piece part in sliding connection with the snap-fit wall 305. The sliding connection is of the maintained type and is ensured by at least one rail. More particularly, and as shown in FIG. 6, the at least one rail can comprise two rails 310 and 320 (FIG. 2). Each rail 310 and 320 extends notably along the sliding direction from the contact face, and is discontinuous at the intermediate part. This discontinuity makes it easier to bend the second part with respect to the first part.

“Of the maintained type” is understood to mean a locking member that is hooked onto the at least one rail.

More particularly, the rail 310 comprises a first portion 310a and a second portion 310b carried, respectively, by the first section and the second section.

Equivalently, the rail 320 comprises a first portion 320a and a second portion 320b carried, respectively, by the first part and the second part.

Thus, the locking member, when it is in its locked position, is engaged in one and the other of the first portion 310a, 320a and the second portion 310b, 320b of the at least one rail so as to mechanically secure the first part and the second part together. This mechanical connection between the first part and the second part stiffens the snap-fit wall and makes it difficult, if not impossible, for the second part 305c to bend.

When it is in its unlocked position, the locking member is engaged exclusively in the second portion 310b, 320b, so as to allow bending of the second section upon insertion of the main body 201 into the female housing 306.

In a particularly advantageous manner, the locking member can be configured to be snap-fitted against the second part when it is in its unlocked position, and against the first part, when it is in its locked position.

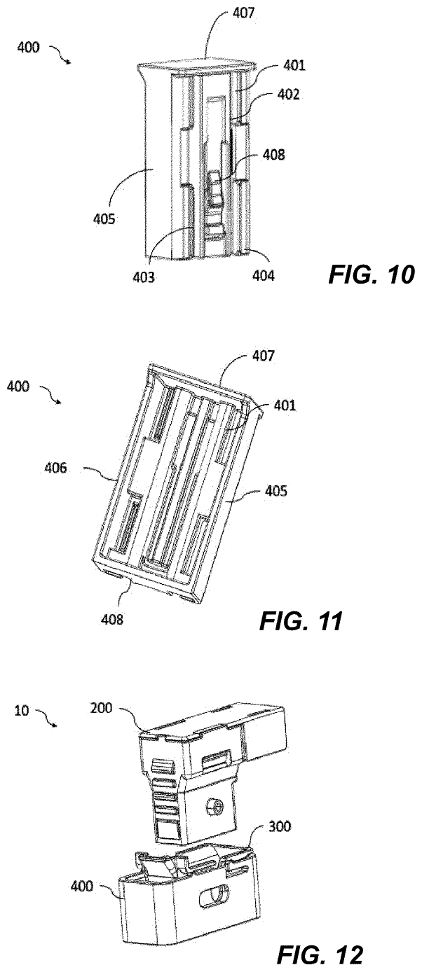

Still advantageously, the locking member 400 can have a form of a rectangular parallelepiped. Notably, the locking member 400 (shown in FIG. 10) may comprise a bottom 401 carrying on one of its faces, a so-called guide face 402, at least one counter-rail engaging with the at least one rail. Notably, the at least one counter-rail may comprise a first counter-rail 403 and a second counter-rail 404.

The snap-fitting of the locking member 400 can be performed by auxiliary snap-fit means carried, respectively, by the bottom 401 and the snap-fit wall 305. Notably, the snap-fit wall may comprise a first lug 311 and a second lug 312 (FIG. 7) formed, respectively, by the first part 305a and the second part 305c.

The bottom 401 may be provided with a tab 408 (for example, obtained by cutting the bottom 401) configured to engage with one and the other of the first lug 311 and the second lug 312 when the locking member is, respectively, in the locked position and the unlocked position.

The locking member 400 may comprise two side walls 405, 406 and a thrust wall 407 connecting the two side walls 405, 406. The two side walls 405, 406 and the thrust wall 407 notably surmount the bottom 401 by one of its faces opposite the guide face 402. The locking member 400 may also comprise an auxiliary wall opposite the thrust wall 407, also surmounting the bottom 401 by its face opposite the guide face 402, and connecting the two side walls 405, 406.

It is understood that when the locking member is mounting in sliding connection on the female casing, the thrust wall is opposite the contact face.

This structure of the locking member 400 provides sufficient rigidity so that, when it is in its locked position, it can effectively lock the main body in its snap-fitted position.

FIG. 12 shows a second example of a connector 10 according to the present disclosure.

Like the device shown in FIG. 2, the connector 10, according to this second example, comprises the male casing 200, the female casing 300, the locking member 400 and the connection member.

Furthermore, the connector 10 according to this second example essentially has the same features as in the first example.

However, the connector 10 according to this second example comprises another arrangement for the locking member and the snap-fit and complementary snap-fit means.

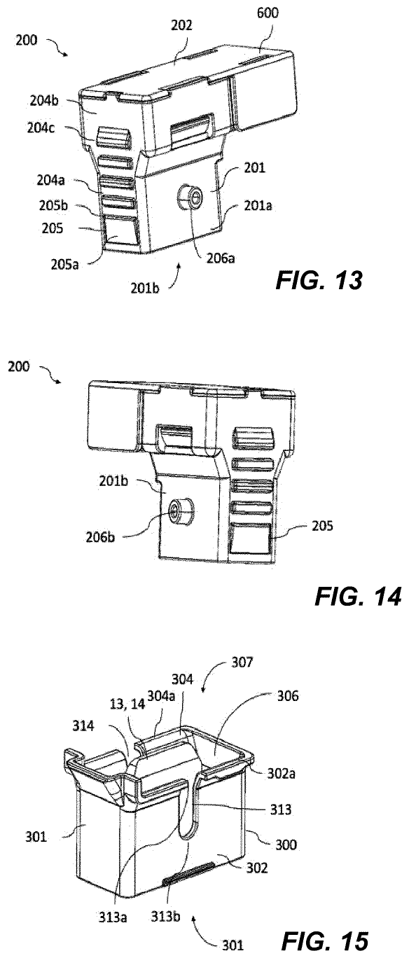

The male casing 200 (shown in FIG. 13) remains very similar to the male casing shown in the first example and has most of the same features. The male casing 200 differs, however, in that the snap-fit means, and more specifically, the lug 205 is formed on the first section 204a.

As shown in FIG. 13 and FIG. 14, the male casing 200 also comprises two studs 206a and 206b each arranged on a different side face adjacent to the main section 204a, so-called guide faces. The stud 206a and the stud 206b are notably configured to be guided toward an insertion position, by guide means formed on two side walls adjacent to the snap-fit wall 305, and so-called guide walls 302 and 304.

The insertion position of the studs 206a and 206b is a position in which the male casing 200 is in the snap-fit position.

The two studs 206a and 206b are also configured to engage with the locking member so that, when it is in its locked position, the locking member locks the studs in their insertion position. This aspect will be described in more detail in the remainder of the wording of the present disclosure.

The female casing 300, according to this second example, is shown in FIG. 15. The latter essentially has all the features of the female casing described in relation to the first example. However, in this second example, the complementary snap-fit means are carried by the first part 305a. These complementary snap-fit means can notably be arranged inside the female housing 306. By way of example, these complementary snap-fit means may comprise a groove, a notch or any other pattern that can engage with the snap-fit means of the male casing to hold it by snap-fitting into the snap-fit position.

It is understood that the female casing is not necessarily provided with the second part.

The guide means may comprise two notches 313 and 314 formed, respectively, on the guide wall 302 and on the guide wall 304 (FIG. 15).

Notably, the guide notch 313 of the guide wall 302 extends from a guide inlet 313a (formed at the inlet edge 302a) toward the contact face to terminate in an abutment end 313b at a distance from the contact face (FIG. 15).

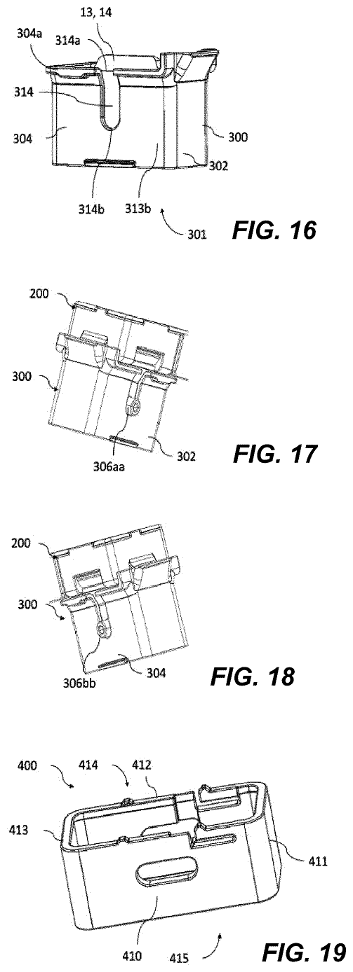

Equivalently, the guide notch 314 of the guide wall 304 extends from a guide inlet 314a (formed at the inlet edge 304a) toward the contact face to terminate in an abutment end 314b at a distance from the contact face (FIG. 16).

The guide notches 313 and 314 are configured so that when the main body 201 is inserted into the female housing 306, each stud 206a and 206b is engaged in a guide notch to be guided along the guide notch up to its insertion position.

Notably, the stud 206a is intended to be guided by the guide notch 313, while the stud 206b is intended to be guided by the guide notch 314.

Each stud 206a and 206b, once it is engaged in a guide notch 313 and 314, comprises an end portion projecting with respect to the guide wall carrying the guide notch 313 and 314 in question, and intended to engage with the locking member.

By way of example, FIG. 17 shows the stud 206a in its insertion position and in the guide notch 313. Notably, in this figure, the stud 206a passes entirely through the guide wall 302 and therefore comprises a part, a so-called end portion 306aa, projecting with respect to the guide wall 302.

Equivalently, FIG. 18 shows the stud 206b in its inserted position and in the guide notch 314. Notably, in this figure, the stud 206b passes entirely through the guide wall 304 and therefore comprises a part, a so-called end portion 306bb, projecting with respect to the guide wall 304.

The end portions 306aa and 306bb are intended to engage with the locking member shown in FIG. 19.

In this second example, the locking member forms a rectangular parallelepiped and comprises four walls 410, 411, 412 and 413. The locking member 400 comprises two fully open faces, opposite each other and so-called, respectively, the first face 414 and second face 415.

Notably, the first face 414 is delimited by free edges, so-called first edges, of the four walls 410, 411, 412 and 413 accessible via the first face 414.

Equivalently, the second face 415 is delimited by free edges, so-called second edges opposite the first edges, of the four walls 410, 411, 412 and 413 accessible via the second face 415.

The locking member 400 is arranged to be arranged on the connection zone, and more particularly so that its four walls 410, 411, 412 and 413 are arranged around the female casing 300.

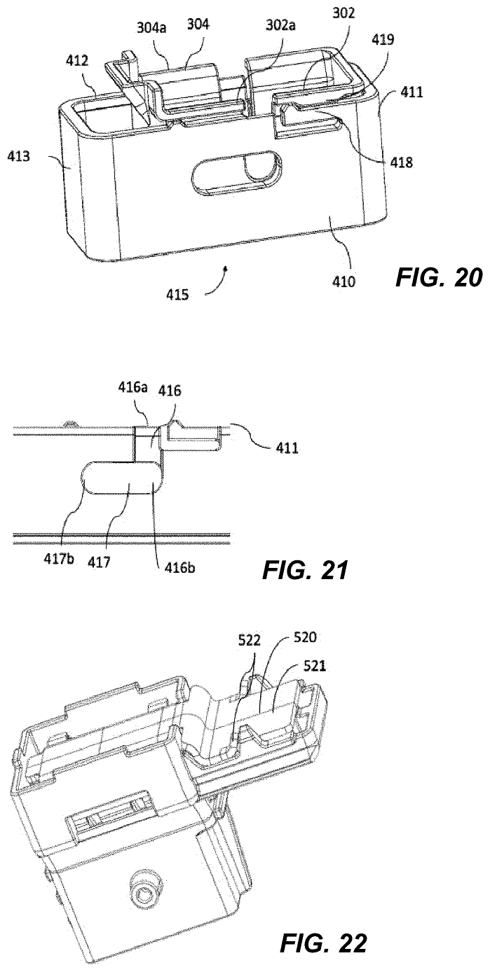

In this respect, FIG. 20 shows the locking member 400 arranged on the connection zone so that its four walls 410, 411, 412 and 413 are arranged around the female casing 300.

Notably, in FIG. 20, the wall 410 faces the guide wall 302, while the wall 412 faces the guide wall 304.

“Faces” is understood to mean being “in contact with” or “in the vicinity of.” Consequently, it is understood without it needing to be specified that the wall 410 is parallel to the guide wall 302 and that the wall 412 is parallel to the guide wall 304.

Furthermore, the locking member 400 rests on the connection zone by its second face. In order to limit the connection between the locking member and the female casing to a sliding connection, the inlet edges 302a and 304a can be divergent and/or externally curved and/or flared.

In other words, the inlet edge 302a rests against the first edge of the wall 410 (also known as the locking wall 410).

Equivalently, the inlet edge 304a rests against the first edge of the wall 412 (also known as the locking wall 412).

According to this configuration, the locking member can slide between one or the other of the locked position and the unlocked position according to a direction perpendicular to the guide notches and lying in a plane defined by one or the other of the guide walls, both walls of the locking member.

Furthermore, the locking walls are each adapted to engage with an end portion of a stud.

Notably, when the locking member is in its unlocked position, each stud can be freely guided in a guide notch, whereas when the locking member is in its locked position, each stud is locked in its insertion position.

As shown in FIG. 21, each guide wall comprises on its inner face a guide trench 416, which extends from a first end 416a to a second end 416b and parallel to the guide notches. Each locking wall also comprises an oblong hole 417, which extends perpendicularly to the guide trench 416 and from the second end 416b of the guide trench to a third end 417b.

The guide trench 416 is arranged so that, when the locking member is in its unlocked position, the guide trench 416 is opposite one of the guide notches and makes it possible to guide the end portion of a stud, from the first end 416a up to the second end 416b, and cause the stud to adopt its insertion position.

The guide trench is obtained by removing material from the inner face of the guide wall on which the trench is formed. In other words, the bottom of the guide trench is at a distance to allow the end portion of the stud to be guided without interacting with the inner face in question.

The oblong hole 417 is arranged so that when the locking member moves from its unlocked position to its locked position, the end portion is guided from the second end to the third end so as to lock the end portion in its insertion position.

Thus, in operation, and upon insertion of the main body 201 of the male casing 200, the locking member is in its unlocked position. Each guide trench corresponds to a guide notch, thus enabling the end portion of each stud to be guided along one of the guide notches so that the stud reaches its insertion position.

Once the male casing is in the snap-fit position, the locking member can adopt its locked position by guiding each of the end portions into an oblong hole (the oblong hole slides along the end portion of a stud).

Advantageously, each guide wall comprises a flexible retaining lever 418 at its first edge (in contact with a flared edge). The retaining lever 418 is notably adapted to engage with a boss 419 formed on the flared edge, and enable the locking member to be held in one and the other of the locking position and the unlocking position. The boss 419 can be elongated and comprise two sides, respectively, a so-called first side and second side opposite each other. Notably, the retaining lever 418 can be snap-fitted onto the first side of the boss when the locking member is in its locked position, and be snap-fitted onto the second side of the boss when the locking member is in its unlocked position.

Whichever example is considered, the connection member can comprise a contact section, housed in a housing, a so-called connection housing 600, arranged in the extension of the secondary body by one of its faces, opposite the secondary section 204b (FIG. 13).

The contact section 520 (FIG. 5 and FIG. 21) comprises a central part 521, generally planar in shape, and two curved side tabs 522. The two tabs 522 rest on a bed conforming to the connection housing in order to limit relative movements between the connection member and the male casing.

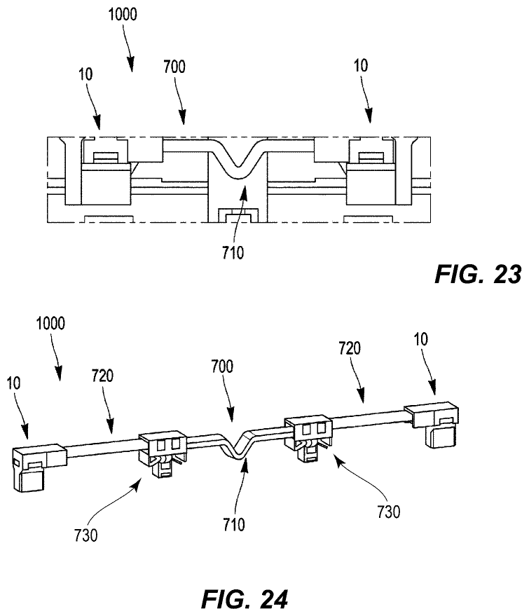

The present disclosure relates to a connection device 1000 for two elementary cells (FIG. 23). The connection device notably comprises a busbar 700 and two connectors according to the present disclosure.

Notably, the busbar extends between two ends, and may feature one or more folds 710 making it flexible. As shown in FIG. 23, each connector is attached to the contact section of the contact member of one of the connectors 10.

According to another example shown in FIG. 24, a secondary busbar 720 can be interposed between each end of the busbar 700 and the connector 10. Clips 730 can be arranged at each connection between the busbar 700 and a secondary busbar 720. These clips can furthermore comprise a foot and a head surmounting the foot. The foot can be equipped with snap-fit means allowing the clip to snap-fit onto a wall of an elementary cell. The head, for its part, is arranged to allow the connection of a busbar and a secondary busbar. This last aspect improves the mechanical cohesion of the connection device when the busbar 700 and secondary busbar 720 have a combined length greater than 30 cm.

The present disclosure also relates to a third example of a connector 10, which essentially repeats the principles set out with regard to the first example and the second example.

Nevertheless, in this third example, the locking member 400 is pivotally connected to the female casing, and can therefore adopt the locked position and the unlocked position by simple rotation.

Notably, the locking member 400, which is generally cylindrical in shape, is mounted coaxially with a spring element 500a and the connection member 500, both of which are generally cylindrical in shape. More particularly, the connection member 500 is housed in the spring element 500a, which is itself housed in the locking member 400. In this respect, the locking member when it is in its locked position, releases the spring element so that the latter exerts a force tending to tighten the connection member.

Of course, the present disclosure is not limited to the described embodiments and variant embodiments may be envisaged without departing from the scope of the invention as defined by the claims.

1. A connector for electrically connecting a terminal of an elementary cell of a battery pack, the terminal projecting with respect to a connection zone of the elementary cell, the connector comprising:
a male casing provided with a main body, forming a male housing, accessible for a male opening formed on a lower face of the main body;
a female casing intended to be attached to the connection zone by a contact face of the female casing, the female casing forming a female housing, wherein the terminal is housed, the female casing comprising an insertion opening on an insertion face of the female casing, the female housing generally conforming to the main body so as to allow the insertion of the main body, by the lower face of the main body, in the female housing, and maintenance by snap-fitting of the male casing in a snap-fit position;
a connection member arranged in the male housing and configured to form a contact with the terminal when the main body is in the snap-fit position; and
a locking member in sliding connection or pivot connection with the female casing, the locking member capable of adopting, according to a sliding movement or according to a rotational movement, one or the other of a locked position and an unlocked position, the unlocked position being a position in which the locking member allows the insertion of the main body into the female housing to adopt the snap-fit position, the locked position being a position in which the locking member locks the main body in the snap-fit position.

2. The connector of claim 1, wherein the male casing forms a rectangular parallelepiped, while the female casing comprises four side walls, the insertion face being opposite the contact face.

3. The connector of claim 2, wherein the main body comprises four side faces, and the male casing also comprises a secondary body in the form of a rectangular parallelepiped, the secondary body surmounting the main body by a face opposite the lower face, the secondary body having a form of a rectangular parallelepiped, a secondary section of the secondary body, extending a main section in a coplanar manner, the main section and the secondary section together forming a snap-fit face carrying snap-fit means, and configured to engage with complementary snap-fit means carried by the female casing.

4. The connector of claim 3, wherein the complementary snap-fit means are carried by a snap-fit side wall of the female casing facing the snap-fit face.

5. The connector of claim 4, wherein the snap-fit wall comprises, along a sliding direction perpendicular to the contact face, and from the contact face, a first part, an intermediate part and a second part carrying the complementary snap-fit means, side edges of the intermediate part and of the second part being free in order to allow a bending of the second part around an axis perpendicular to the sliding direction and comprised in the intermediate part, during snap-fitting of the male casing with the female casing.

6. The connector of claim 5, wherein the locking member is formed by a one-piece part in sliding connection according to a guiding mode maintained by way of at least one rail, each rail from the at least one rail, extending along the sliding direction from the contact face, is discontinuous at the intermediate part and comprises a first portion and a second portion, respectively, carried by the first part and the second part, wherein the locking member, when in the locked position, is engaged in one and the other of the first portion and the second portion of the at least one rail so as to mechanically secure the first part and the second part, wherein the locking member, when in the unlocked position, is engaged exclusively in the second portion of the at least one rail.

7. The connector of claim 6, wherein the locking member is configured to be snap-fitted against the second portion when in the unlocked position, and against the first portion and against the first portion when in the locked position.

8. The connector of claim 6, wherein the locking member is in the form of a rectangular parallelepiped and comprises a bottom carrying on a guide face at least counter-rail engaging with the at least one rail, the bottom being further surmounted, by one of its faces opposite the guide face, by two side walls and a thrust wall.

9. The connector of claim 4, wherein the main body comprises two studs each arranged on a different side guide face adjacent to the main section, the two studs being configured to be guided toward an insertion position, by guide means formed on two side walls adjacent to the snap-fit wall, and guide walls, the insertion position being a position for which the male casing is in the snap-fit position, the two studs also being configured to engage with the locking member so that, when it is in the locking position, the locking member locks the studs in their insertion position.

10. The connector of claim 9, wherein the means for guiding a guide wall comprises a guide notch extending from a guide inlet at the insertion face toward the contact face, to terminate in an abutment end, at a distance from the contact face, the guide notches being configured so that when the main body is inserted into the female housing, each stud is engaged in a guide notch to be guided along the guide notch up to its insertion position.

11. The connector of claim 10, wherein each stud, once it is engaged in a guide notch, comprises an end portion projecting with respect to the guide wall carrying the respective guide notch, the end portion configured to engage with the locking member.

12. The connector of claim 11, wherein the locking member is in the form of a rectangular parallelepiped, the locking member comprising four walls arranged around the side walls of the female casing, the locking member being arranged to slide between one and the other of the locked position and the unlocked position along a direction perpendicular to the guide notches and comprised in a plane defined by one or the other of the guide walls, two locking walls of the locking member, each facing a guide wall and configured to engage with the end portion of a stud so that when the locking member is in the unlocked position, each stud can be guided freely in a guide notch, and so that when the locking member is in the locked position, each stud is locked in the insertion position.

13. The connector of claim 12, wherein each locking wall comprises, on an inner face of the locking wall, a guide trench extending from a first end toward a second end and parallel to the guide notches, each locking wall also comprising an oblong hole extending perpendicularly to the guide trench and from the second end of the guide trench toward a third end, the guide trench being arranged so that, when the locking member is in the unlocked position, the guide trench is opposite one of the guide notches enabling guidance of the end portion of a stud, from the first end up to the second end, and causing the stud to adopt its insertion position, the oblong hole being arranged so that when the locking member goes from the unlocked position to the locked position, the end portion is guided from the second end toward the third end so as to lock the end portion in the insertion position.

14. The connector of claim 13, wherein each of the guide walls comprises a flared edge, each flared edge partially providing the sliding connection between the female casing and the locking member.

15. The connector of claim 14, wherein each guide wall comprises a retaining lever at an edge of the guide wall, the retaining lever being in contact with a flared edge, the retaining lever being adapted to engage with a boss formed on the flared edge, and to allow the locking member to be maintained in one and the other of the locking position and the unlocking position.

16. The connector of claim 3, wherein the connection member comprises at least one clip, the at least one clip comprising a base from which two wings extend, essentially symmetrically with respect to the base, between which the terminal, of planar shape, is configured to be inserted when the main body is in the snap-fit position.

17. The connector of claim 3, wherein the connection member comprises a contact section, housed in a connection housing, arranged in an extension of the secondary body by a face of the secondary body, opposite the second part.
